(19) United States
(12) Patent Application Publication
(10) Pub. No.: US 2009/0295939 A1
(43) Pub. Date: Dec. 3, 2009

(54) IMAGING DEVICE

(75) Inventor: Nobuaki ABE, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/472,607

(22) Filed: May 27, 2009

(30) Foreign Application Priority Data
May 29, 2008 (JP) 2008-141456

(51) Int. Cl. H04N 9/73

(52) U.S. Cl. 348/223.1; 348/E09.052

(57) ABSTRACT

An Imaging device has an Image sensor with a mosaic color filter array comprising three or four color elements. The color elements are arrayed such that each color element is opposite a pixel in said image sensor. The imaging device further has a color-transform a processor that carries out a color-transform process on a color signal in each pixel to generate a single color-transform signal in each pixel; and a color interpolation processor that interpolates at least one missing color-transform signal in each pixel using color-transform signals from surrounding pixels. The color-transform processor interpolates at least one missing color signal in each pixel using color signals generated over adjacent pixels, and multiplies the originally generated color signal and the interpolated color signal by color-transform coefficients to generate the single color-transform signal.

### BACKGROUND OF THE INVENTION

1. Field of the Invention

The present invention relates to an imaging device that generates a color image on the basis of image-pixel signals read from an image sensor such as a CCD. In particular, it relates to a color interpolation process performed when using a single imaging sensor which employs a color filter array.

2. Description of the Related Art

In a digital camera, an image sensor with an on-chip color filter array is generally used. For example, a Bayer-type mosaic color filter, composed of color elements R, G, and B, is provided in an image sensor. Each pixel in the image sensor opposes one color element and receives light of a wavelength corresponding to the opposing color element.

Since each pixel has only one color signal component corresponding to the opposing color element, a color interpolation process (called “demosaicing”) is carried out, in which color information which is missing in a target pixel is obtained from color signals generated by adjacent pixels.

As for color interpolation, various interpolation methods, such as one that calculates an average from the color signals of neighboring pixels, to one that uses a pixel adjacent to a target pixel which is relatively strongly correlated, etc., have been proposed. These interpolation processes aim to decrease the occurrence of false color or to enhance the resolution of an image, in other words, the sharpness of an image.

Generally, there is a trade-off between the occurrence of false color and the sharpness of an image. In the case of the average-calculating method, although “false color” is avoided, contrast and resolution in an image decrease since a low-pass filter function acts. On the other hand, the method using a pixel-wise, relatively strong correction (and particularly, using pixels which are not next to, but closest to the target pixel), enhances contrast and resolution in an image, however, false color, may still occur.

### SUMMARY OF THE INVENTION

An object of the present invention is to provide an imaging device, and an apparatus/method for interpolating color signals that are capable of enhancing resolution in an image and preventing the occurrence of false color.

An imaging device according to the present invention has an image sensor with a mosaic color filter array comprising three or four color elements. The color elements are arrayed such that each color element is opposed to a pixel in the image sensor.

The imaging device has also a color-transform processor that carries out a color-transform process to a color signal in each pixel to generate single color-transform signal in each pixel; and a color interpolation processor that interpolates at least one missing color-transform signal in each pixel by using color-transform signals from surrounding pixels. The color-transform processor interpolates at least one missing color signal in each pixel by using color signals generated over adjacent pixels, and multiplies the originally generated color signal and the interpolated color signal by color-transform coefficients to generate the single color-transform signal.

Koto that, herein, an “adjacent pixel” refers to any neighboring pixels, (i.e., pixels next to a target pixel and any pixels close to the target pixel, but not next to the target pixel, also, a “surrounding pixel” includes, herein, neighboring pixels and those adjacent, as well as pixels other than the adjacent pixels.

An apparatus for interpolating color signals, according to another aspect of the present invention, has a color-transform processor that carries out a color-transform process on a color signal in each pixel to generate a single color-transform signal in each pixel of an image sensor; and a color interpolation processor that interpolates at least one missing color-transform signal in each pixel using color-transform signals from surrounding pixels, the color-transform processor interpolating at least one missing color signal in each pixel using color signals generated over adjacent pixels, the color-transform processor multiplying the originally generated color signal and the interpolated color signal by color-transform coefficients to generate the single color-transform signal.

A method for interpolating color signals, according to another aspect of the present invention, includes: a) carrying out a color-transform process on a color signal in each pixel to generate a single color-transform signal in each pixel of an image sensor; and b) interpolating at least one missing color-transform signal in each pixel using color-transform signals from surrounding pixels, the color-transform process interpolating at least one missing color signal in each pixel using color signals generated over adjacent pixels, the interpolating comprising multiplying the originally generated color signal and the interpolated color signal by color-transform coefficients to generate the single color-transform signal.

### BRIEF DESCRIPTION OF THE DRAWINGS

The present invention will be better understood from the description of the preferred embodiments of the invention set forth below, together with the accompanying drawings, in which:

FIG. 1 is a block diagram of a digital camera according to a first embodiment;

FIGS. 2A and 2B partially illustrate a color filter array and a pixel array;

FIG. 3 is a flowchart of a series of image-signal processes used to generate the color-transform signals;

FIG. 4 illustrates color signals read from the CCD 14;

FIG. 5 illustrates color-transform signals corresponding to 5×5 pixel array;

FIG. 6 illustrates color-transform signals used for Interpolating color-transform signals of “G” with respect to a pixel P₁₃;

FIG. 7 illustrates color-transform signals used for interpolating color-transform signals of “B” with respect to a pixel P₁₃;

FIG. 8 shows a graph representing the frequency of false color when a CZP chart is used as a subject;

FIG. 9 shows a graph of resolution performance represented by a wedge chart;

FIG. 10 is a block diagram of a digital camera according to the second embodiment;

FIG. 11 illustrates a color filter array according to the second embodiment;

FIG. 12 illustrates spectrum transmittance characteristics of the color filter array;

FIG. 13 illustrates color signals read from a CCD in accordance with 5×5 pixel array;

FIG. 14 shows a graph F representing of the extent of false color occurrence when the subject is a CZP chart; and

FIG. 15 shows a graph of resolution performance using a wedge chart.

### DESCRIPTION OF THE PREFERRED EMBODIMENTS

Hereinafter, the preferred embodiments of the present invention are described with reference to the attached drawings.

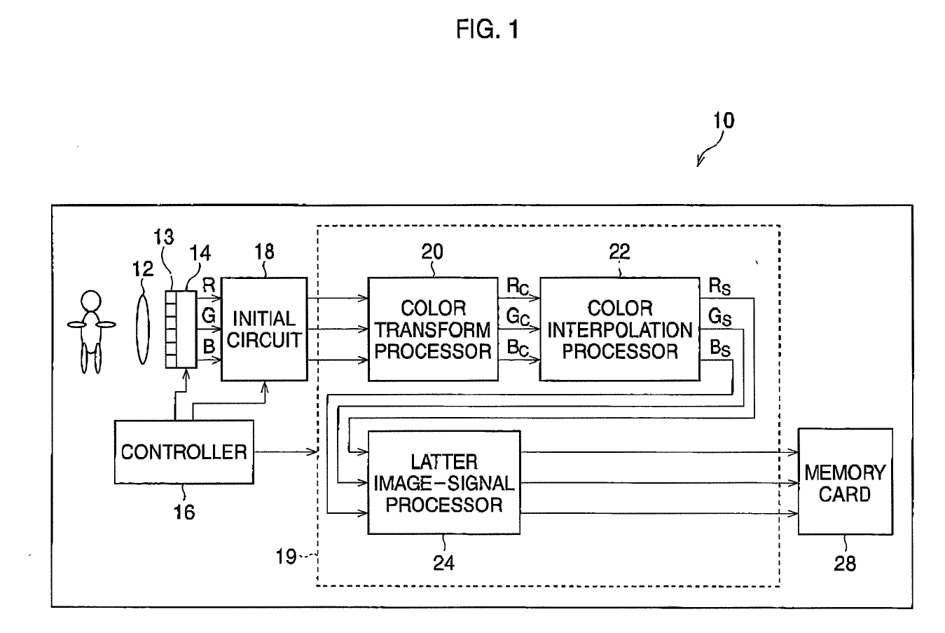

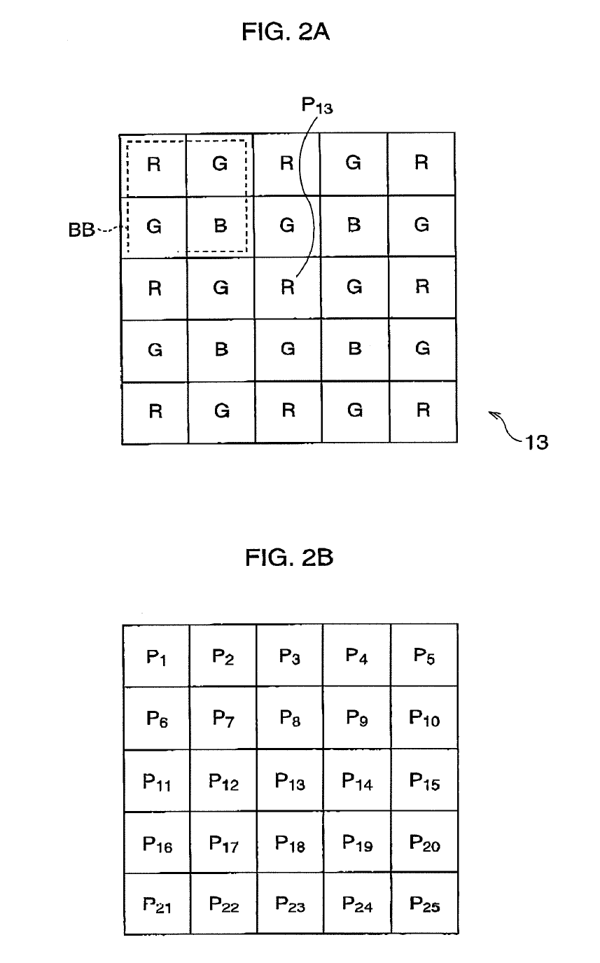

FIG. 1 is a block diagram of a digital camera according to a first embodiment. FIGS. 2A and 2B partially illustrate a color filter array and a pixel array.

A digital camera 10 is equipped with a photographing optical system 12 and a CCD 14, and a controller 16 including a ROM, RAM, and CPU, which carry out a photographing process by controlling an action of the camera 10. When a release button (not shown) is operated, a photographing action is carried out as explained below.

Light reflected off a subject passes through the photographing optical system 12 and a shutter (not shown) and finally reaches a CCD 14 such that an object image is formed on a light-receiving surface of the CCD 14. In this embodiment, the imaging method using a single imaging device is applied, and on-chip color filter 13 is also provided in the CCD 14.

The color filter array 13 shown in FIG. 2A is a Bayesian color filter array, in which three color elements “R, G, and B” are arrayed alternately. Also, the color filer array 13 is a standard Bayesian filer composed of a plurality of blocks having BB of R, G, B, and G elements, which are next to each other. The R and G elements are arrayed alternately in odd lines, while the B and G elements are arrayed alternately in even lines. Each pixel in the CCD 14 is opposite one of the three color elements. In FIG. 2B, there is a 5×5 pixel array Pⱼ (1≦j≦25), which is a part of the CCD 14 and also opposite the color filter array shown in FIG. 2A, as shown. For example, a pixel Pia is opposite a color element “R”. And also, pixels P₈, P₁₂, P₁₄, and P₁₈, which are next to pixel P₁₃ in the horizontal and vertical lines are opposite a color element “G”; and pixels P₇, P₉, P₁₇, and P₁₉, which arc next to the pixel P₁₃ in a diagonal lines are opposite a color element “B”.

In the CCD 14, analog image-pixel signals based on the color filter array 13 are generated, and one frame's worth of image-pixel signals (i.e., RAW data) are read from the CCD 14 on the basis of driving signals fed from the controller 16. The series of image-pixel signals is converted from the analog signals to digital signals in an initial circuit 18, and is transmitted to a color-transform processor 20, provided in a chip-type image-signal processing circuit 19, built as a DSP (Digital Signal Processor).

In the color-transform processor 20, a color transform process is carried out in each pixel. Herein, missing color signals are temporarily interpolated using color signals generated in neighboring pixels, and a single color-transform signal, which corresponds to one of R, G, and B color elements, is generated on the basis of the original color signal and the interpolated color signals. The color-transform signal generated in each pixel (Rc, Gc, or Be) is transmitted to a color interpolation processor 22.

In the color interpolation processor 22, the color-transform signal in each pixel is temporarily stored in a memory (not shown) and subjected to a color interpolation process. Thus, three color-transform signals Rs, Gs, and Bs are generated in each pixel and output to a latter image-signal processor 24.

In that latter image-signal processor 24, the series of color-transform signals Rs, Gs and Bs in each pixel are subjected to various processes, such as a white balance adjustment process, gamma correction, edge enhancement, etc. Color image data is thus generated and stored in a memory card 28.

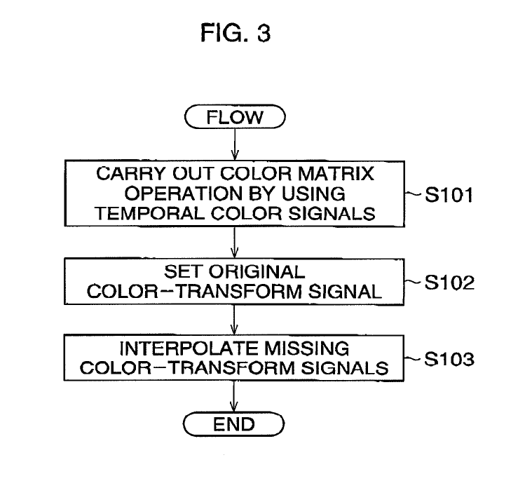

FIG. 3 is a flowchart of a series of image-signal processes used to generate the color-transform signals. The color-transform process and the color interpolation process are explained below in detail.

In the color-transform processor 20, a color signal in each pixel is subjected to a color-transform process to adjust color-balance (S101). At this time, missing color signals in each pixel are temporarily interpolated using color signals generated over neighboring pixels. Then, a matrix operation is carried out on the three color signals in each pixel to obtain a single color-transform signal.

For example, in the case of a pixel which is opposite color element “R”, an average of four color signals “G” generated over four pixels, adjacent to a target pixel in the horizontal and vertical directions, is calculated and is defined as a temporary color signal (hereinafter, we refer to that process using neighboring pixels as, “proximity interpolation process”). On the other hand, a missing color signal “B” is interpolated by calculating an average of four color signals “B” over four pixels, which are next to the target pixel in diagonal directions so that a temporary color signal “B” is generated. Then, the original color signal “Rc” and the interpolated temporary color signals “Gc” and “Bc” in each pixel is multiplied by matrix coefficients (color-transform coefficients), which are based on a color space.

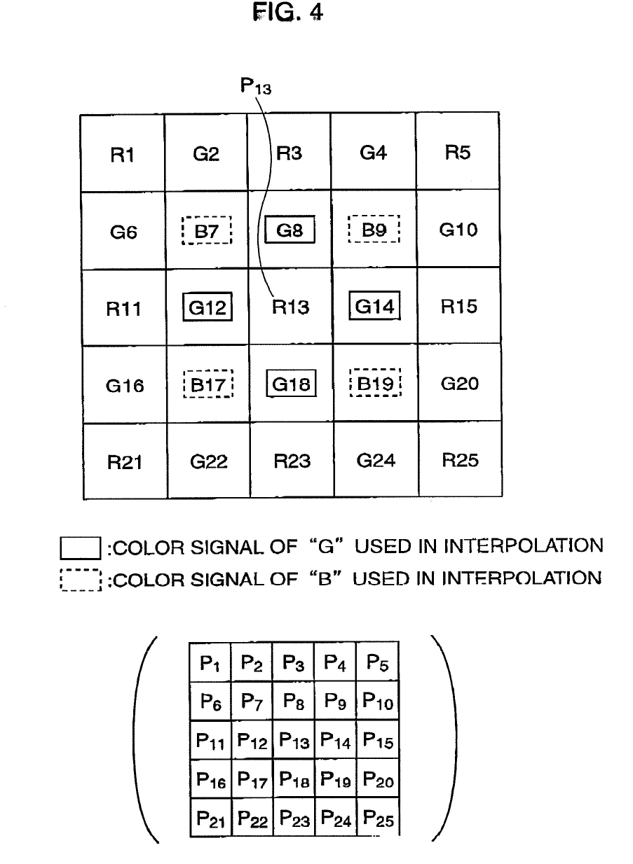

FIG. 4 illustrates color signals read from the CCD 14. Each color signal is designated by the number matching its opposing pixel. In the case of the pixel P₁₃, a color-transform signal Ra13 is calculated using the following formula.

$$Rc 13 = ( \begin{matrix}1.25 & - 0.28 & 0.03\end{matrix} ) ( \begin{matrix}R 13 \\ {G}^{′} 13 \\ {B}^{′} 13\end{matrix} ) \\ ( \begin{matrix}{G}^{′} 13 = ( G 8 + G 12 + G 14 + G 18 ) / 4 \\ {B}^{′} 13 = ( B 7 + B 9 + B 17 + B 19 ) / 4\end{matrix} ) \qquad ( 1 )$$

Herein, the value of each coefficient in the 1×3 matrix shown in the formula (1) is based on the sRGB color space.

The temporary color signal “G′13”, shown in the formula (1), represents an average of color signals “G8, G12, G14, and G18” generated over pixels “P₈, P₁₂, P₁₄, and P₁₈”, which are next to the pixel P₁₃ in the vertical and horizontal directions. Also, the temporary color signal “B′13” represents an average of color signals “B7, B9, B17, and B19” generated over pixels “P₇, P₉, P₁₇, and P₁₉”, which are next to the pixel P₁₃ in diagonal directions.

On the other hand, in the case of a pixel which is opposite a color element “G”, the proximity interpolation process is carried out using four pixels opposite “R” and “B” color elements, which are next to a target pixel in the horizontal and vertical directions. Thus, temporary color signals “R” and “B” are generated. Then, a matrix operation is carried out on the color signal “G” and the generated temporary color signals “R” and “B”. For example, in the case of the pixel P₁₄, a color-transform signal Gc14 is obtained using the following formula.

$$Gc 14 = ( \begin{matrix}- 0.77 & 2.13 & - 0.35\end{matrix} ) ( \begin{matrix}{R}^{′} 14 \\ G 14 \\ {B}^{′} 14\end{matrix} ) \\ ( \begin{matrix}{R}^{′} 14 = ( R 13 + R 15 ) / 2 \\ {B}^{′} 14 = ( B 9 + B 19 ) / 2\end{matrix} ) \qquad ( 2 )$$

Furthermore, in the case of a pixel which is opposite a color element “B”, the proximity interpolation process is carried out using four pixels opposite “G” color elements, which are next to a target pixel in the horizontal and vertical directions. Thus, temporary color signals “R” and “G” are generated. Then, a matrix operation is carried out on the color signal “B” and the generated temporary color signals “R” and “G”. For example, in the case or the pixel P₁₉, a color-transform signal Bc19 is obtained using the following formula.

$$Bc 19 = ( \begin{matrix}0.05 & - 0.59 & 1.54\end{matrix} ) ( \begin{matrix}{R}^{′} 19 \\ {G}^{′} 19 \\ B 19\end{matrix} ) \\ ( \begin{matrix}{R}^{′} 19 = ( R 13 + R 15 + R 23 + R 25 ) / 4 \\ {G}^{′} 19 = ( G 14 + G 18 + G 20 + G 24 ) / 4\end{matrix} ) \qquad ( 3 )$$

The matrixes used in the formulae (1) to (3) are used in a color-transform process on a pixel of corresponding color element.

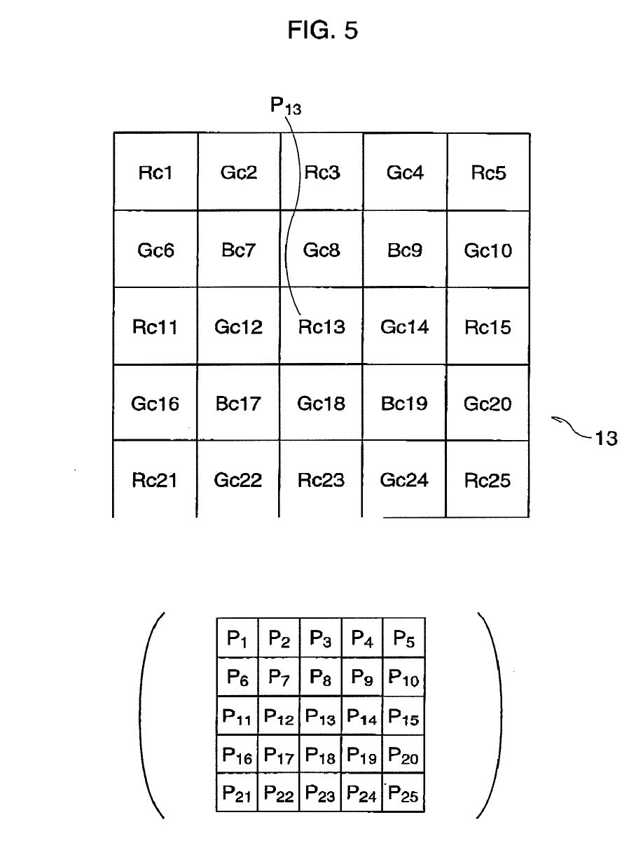

FIG. 5 illustrates color-transform signals corresponding to 5×5 pixel array. One of three color-transform signals “Rc, Gc, and Bc” is generated in each pixel. For example, the pixel P₁₃ has only one color-transform signal Rc13. In the color interpolation processor 22, missing color-transform signals are interpolated so that three color signals corresponding to color elements “R”, “G”, and “B” are generated and output (Step S102 and S103 in FIG. 3). Herein, an interpolation process, which utilizes a color-transform signal of a pixel having a relatively strong correlation to a target pixel, is carried out (hereinafter, this interpolation process is called, “correlation interpolation process”).

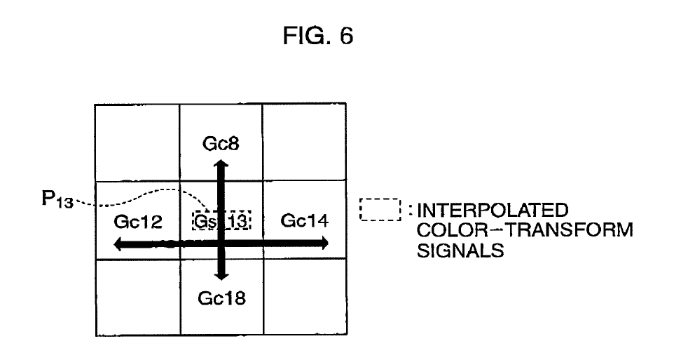

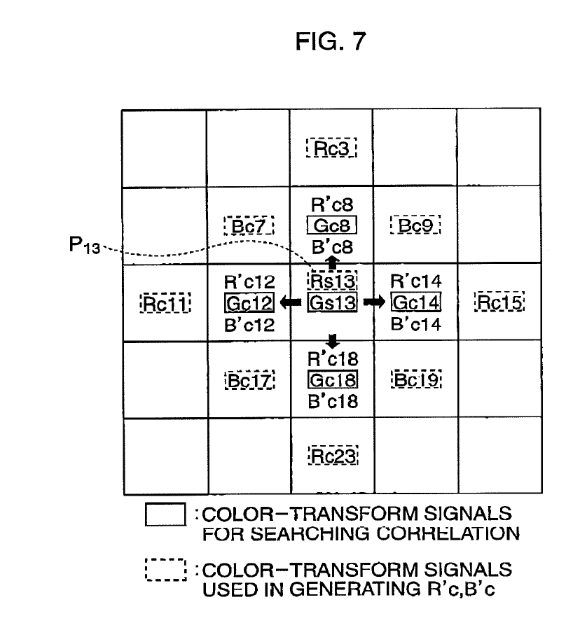

FIG. 6 illustrates color-transform signals used for interpolating color-transform signals of “G” with respect to a pixel P₁₃. FIG. 7 illustrates color-transform signals used for interpolating color-transform signals of “B” with respect to a pixel P₁₃. The correlation interpolation process is concretely explained below.

In the case of the pixel P13, the color-transform signal Rc13 is set to a color-transform signal Rs13 to be directly output from the color-interpolation processor 22. On the other hand, color-transform signals Gs13 and Bs13 are generated by the correlation interpolation process.

To calculate the color-transform signal Gs13 corresponding to the color element “G”, two directions, i.e. , a vertical direction along color-transform signals Gc8 and Gc18 of the pixel P₈ and P₁₈ and a horizontal direction along color-transform signals Gc12 and Gc14 of the pixel P₁₂ and P₁₄ are compared with each other, with respect to a correlation with the target pixel P₁₃. Note the pixel P₈, P₁₂, P₁₄, and P₁₈ are next to the pixel P₁₃ in horizontal and vertical directions , and are based on the color signals read from the CCD 14. Concretely, a difference ΔGv between color transform signals Gc8 and Ge18 along the vertical direction (=|Gc8−Gc18|) and a difference ΔGh between color transform signals Gc12 and Gc14 along the horizontal direction (=|Gc12−Gc14|) are compared with each other.

Then, based on the difference ΔQv or ΔGh, the color-transform signal Gs13 is newly obtained by the following formula.

Gs13=(Gc8+Gc18)/2 (ΔGv<ΔGh)

Gs13=(Gc12+Gc14)/2 (ΔGv≧ΔGh) (4)

When the difference ΔGv is less than the difference ΔGh (i.e. , ΔGv<ΔGh), it is determined that the correlation along the vertical direction is stronger than the horizontal direction, and an average of the color-transform signals Gc8 and Gc18 along the vertical directions is defined as a color-transform signal Gs13. On the other hand, when the difference ΔGv is greater than or equal to the difference ΔGh (ΔGv≧ΔGh), (the average of the color-transform signals Gc12 and Gc14 in the vertical direction), is defined as color-transform signal Gs13.

After the color-transform signal Gs13 corresponding to the “G” element is generated, the color-transform signal Bs13 is then calculated. The pixels P₇, P₉, P₁₇, and P₁₉) corresponding to element “R” are next to the pixel P₁₃ in the diagonal directions. However, herein, the color-transform signal Rs13 is not directly calculated from the color-transform signals Bc7, Bc9, Bc17, and Bc19 of the neighboring pixels P₇, P₉, P₁₇, and P₁₉. Instead, the degree of correlation between the pixel P₁₃ and four directions, namely, the upper sided pixel P₈, the lower side pixel P₁₈; the left side pixel P₁₂, and the right side pixel P₁₄; are calculated by using the color-transform signal corresponding to the “G” element whose number is more than the “R” and “B” elements. Then, the color-transform signal Bs13 is calculated on the basis of the calculated correlation and the color space representing the relationship between R, G, and B signals and color difference signals Y, Cb, and Cr.

Firstly, the differences between the color-transform signal Gs13 calculated by the formula (4) and the color-transform signals Gc6, Gc12, Gc14, and Gc18 of the four neighboring pixels P₈, P₁₂, P₁₄, and P₁₈, are obtained as shown in the following formula. ΔGvu, ΔGvb, ΔGhr, ΔGhl represent the differences regarding the upper direction, the lower direction, the rightward direction, and leftward direction, respectively.

ΔGvu=|Gc8−Gs13|

ΔGvb=|Gc18−Gs13|

ΔGhr=|Gc14−Gs13|

ΔGhl=|Gc12−Gs13| (5)

Then, the differences ΔGvu, ΔGvb, ΔGhr, and ΔGhl are compared with each other to determine which direction has the strongest correlation with the pixel P₁₃. Concretely speaking, the neighboring pixel with minimal such difference is selected from the four neighboring pixels so as to be employed in the interpolation process.

For example, when the difference ΔChl is minimal, the color-transform signal Gc12 of the left side pixel P₁₂ has the strongest correlation with the color-transform signal Gc13 of pixel P₁₃, the color-transform signal Bs13 thus being obtained by the following formula.

$$Bs 13 = Rc 13 + 1.772 * Cb - 1.402 * Cr \\ ( \begin{matrix}Cb = - 0.169 * {R}^{′} c 12 - 0.331 * Gc 12 + 0.5 * {B}^{′} c 12 \\ Cr = 0.5 * {R}^{′} c 12 - 0.419 * Gc 12 - 0.081 * {B}^{′} c 12 \\ {R}^{′} c 12 = ( Rc 11 + Rc 13 ) / 2 \\ {B}^{′} c 12 = ( Bc 7 + Bc 17 ) / 2\end{matrix} ) \qquad ( 6 )$$

The formula (6) is based on the relationship between luminance and color difference signals (Y, Cb, and Cr) and R, G, and B color signals. This relationship is obtained, from the color area of the sRGB space, as well known in prior art. The color difference Cb(=(B−Y)/1.772) and Cr(=(R−Y)/1.402) of the neighboring pixel P₁₂, are also calculated, and the color-transform signal Bs13 is calculated on the basis of the color-transform signal Rs13 (=Rc13) and the color difference signals Cb and Cr.

As can be seen from formula (6), the color-transform signals Rc12 and Bc12 obtained by the first interpolation process and the color-transform process, is not utilized, rather, provisional color-transform signals R′c12 and B′c12 corresponding to the neighboring pistol P₁₂ are used. The provisional color-transform signals R′c12 are an average of the color-transform signal Rc11 corresponding to the adjacent pixel P₁₁ and the color-transform signal Rc13. On the other hand, the provisional color-transform signals B′c12 are an average of the color-transform signals Bc7 and Bc17 of the neighboring pixels P₇ and P₁₇. All of the color-transform signals, Rc11, Rc13, Bc7, and Bc17, are based on color signals directly read from the CCD 14.

When the differences ΔGvu, ΔGvb, or ΔGhr are minimal, the color-transform signals Bs13 is calculated using one of the following formulae.

$$\begin{matrix}Bs 13 = Rc 13 + 1.772 * Cb - 1.402 * Cr \\ ( \begin{matrix}Cb = - 0.169 * {R}^{′} c 14 - 0.331 * Gc 14 + 0.5 * {B}^{′} c 14 \\ Cr = 0.5 * {R}^{′} c 14 - 0.419 * Gc 14 - 0.081 * {B}^{′} c 14 \\ {R}^{′} c 14 = ( Rc 13 + Rc 15 ) / 2 \\ {B}^{′} c 14 = ( Bc 9 + Bc 19 ) / 2\end{matrix} & ( 7 ) \\ Bs 13 = Rc 13 + 1.772 * Cb - 1.402 * Cr \\ ( \begin{matrix}Cb = - 0.169 * {R}^{′} c 8 - 0.331 * Gc 8 + 0.5 * {B}^{′} c 8 \\ Cr = 0.5 * {R}^{′} c 8 - 0.419 * Gc 8 - 0.081 * {B}^{′} c 8 \\ {R}^{′} c 8 = ( Rc 3 + Rc 13 ) / 2 \\ {B}^{′} c 8 = ( Bc 7 + Bc 9 ) / 2\end{matrix} & ( 8 ) \\ Bs 13 = Rc 13 + 1.772 * Cb - 1.402 * Cr \\ ( \begin{matrix}Cb = - 0.169 * {R}^{′} c 18 - 0.331 * Gc 18 + 0.5 * {B}^{′} c 18 \\ Cr = 0.5 * {R}^{′} c 18 - 0.419 * Gc 18 - 0.081 * {B}^{′} c 18 \\ {R}^{′} c 18 = ( Rc 13 + Rc 23 ) / 2 \\ {B}^{′} c 18 = ( Bc 17 + Bc 19 ) / 2\end{matrix} & ( 9 )\end{matrix}$$

FIGS. 6 and 7 show the second interpolation process on the pixel P₁₃, (corresponding to the color element “R”). Similarly, the second interpolation process on a pixel corresponding to the color element “B” (e.g. P₇) is carried out. Namely, the direction having the strongest correlation is selected from among the two directions, i.e., vertical and horizontal directions with respect to the color element “G”, and the interpolation process is carried out to obtain the color-transform signal “G”. Than, the upper, and one among the lower, left, and right side neighboring pixels, which have the strongest correlation with a target pixel, is chosen and the color-transform signal Rs is calculated on the basis of provisional color-transform signals R′c and B′c calculated for the chosen pixel and the color difference signals Cb and Cr. The series of calculations is carried out in each pixel, such that color-transform signals Rs, Gs, and Bs of the entire image may be generated.

In this manner, in the present embodiment, color signals read from the CCD 14 are subjected to the color-transform process, so that one color-transform signal is generated in each pixel. Then, color-transform signals corresponding to color elements R, G, and B are generated in each pixel by the color interpolation process (the correlation interpolation process). In the color-transform process, missing color signals are temporarily interpolated, and the original color signal and the interpolated color signals are multiplied by the matrix coefficients based on the sRGB color space.

Since the proximity interpolation process using neighboring pixels is carried out to generate the temporary color signals before the color-transform process, false color artifacts do not occur. Consequently, the spread or decrease of pixels having false color due to the color-transform process is prevented. On the other hand, as for the color-transform signals, the correlation interpolation process based on the original color signals read from the CCD 14 (the uninterpolated color signals) is carried out. This protects the image from the decrease in resolution such as that referred to as “zipper noise” while also preventing the occurrence of false color, such that a sharp and highly resolved image is obtained. Furthermore, since a single color-transform signal is generated in each pixel, an amount of color-transform signal data to be stored in a memory decreases.

In order to compare the color-transform process and the color interpolation process according to the present embodiment with a prior interpolation process, experimentations for confirming an occurrence of false color and resolution have been performed.

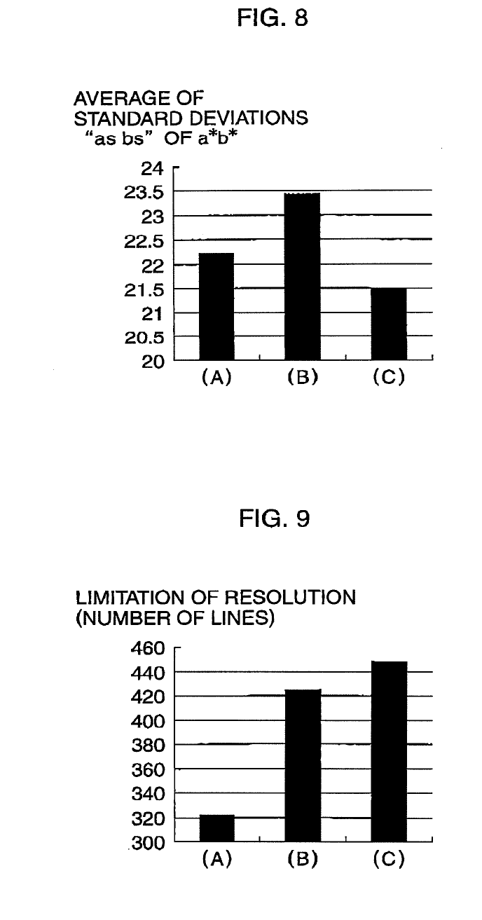

FIG. 8 shows a graph representing the frequency of false color when a CZP chart is used as a subject. Colors in the image produced when using the CZP chart are converted into the L*a*b* color space, and a histogram of color difference components a*b* is obtained. Then, an average of standard deviations “as” and “bs” taken over the color difference components a*b*, is calculated.

Herein, three image-signal processes (A) to (C) were performed. The image-signal processes (A) and (B) carry out a conventional process used for interpolation at once and then carries out a color-transform process. In particular, the image-signal process (A) carries out the proximity interpolation process described above, whereas the image signal process (B) carries out the correlation interpolation process represented by the formulae (5) to (8) before the color-transform process. On the other hand, the image-signal process (c) carries out the first interpolation process (the proximity interpolation process), the color-transform process, and the second interpolation process (the correlation interpolation process) as described above.

The standard deviations “as” and “bs” of the color difference components a*b* represent the degree of unevenness in color in a chart image. When Red to Green occur frequently in an image, the standard deviation “as” becomes large, whereas the standard deviation “bs” tends to become large when Blue to Yellow colors are frequent. Herein, the degree of unevenness in color is regarded as a measure of false color. The occurrence of false color decreases in proportion to the average of the standard deviations of “as” and “bs”.

As shown in FIG. 8, the average of standard deviations according to the present embodiment is smaller than that according to the conventional processes. This indicates that the image-signal process according to the present embodiment succeeds in preventing the occurrence of false color effectively.

FIG. 9 shows a graph of resolution performance represented by a wedge chart. The wedge chart is a resolution chart based on ISO 12233, and an assessment image used is of a resolution of 480×640 pixels. In FIG. 9, the limitation in resolution is shown by the number of lines. As shown in FIG. 9, the resolution of an image resulting from the present embodiment is higher than that obtained using the conventional process.

Therefore, the image-signal process according to the present embodiment produces desirable high-resolution images.

Mote that the second interpolation process may be carried out by the proximity interpolation process rather than by the correlation interpolation process. For example, in the case of the pixel P₁₃, color-transform signals Rs, Gs, and Bs are obtained by the following formula:

Rs13=Rc13

Gs13=(Gc8+Gc12+Gc14+Ge18)/4

Bs13=(Bc7+Bc9+Bc17+Bc19)/4 (10)

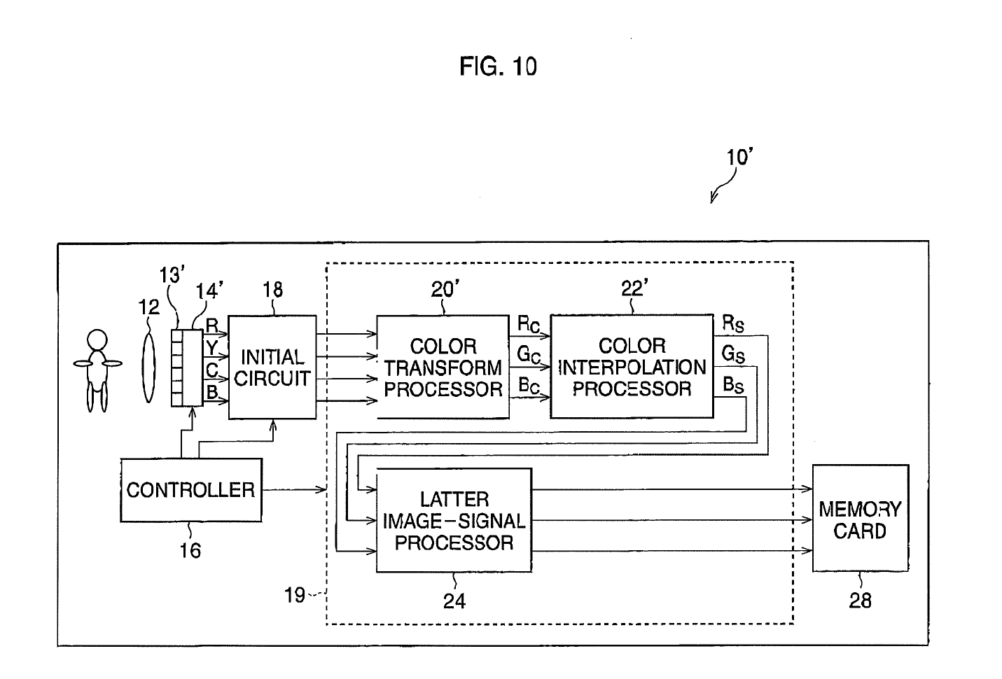

The second embodiment: is explained with reference to FIGS. 10 to 13. The second embodiment differs from the first embodiment in that a color filter array composed of four color elements is used. Other constructions are substantially the same as those of the first embodiment.

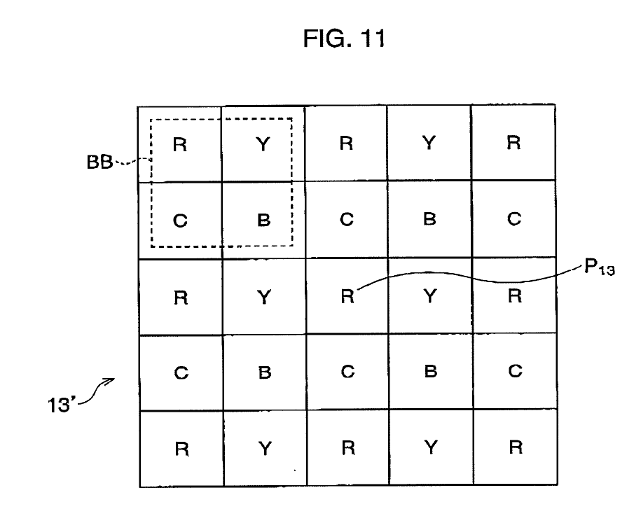

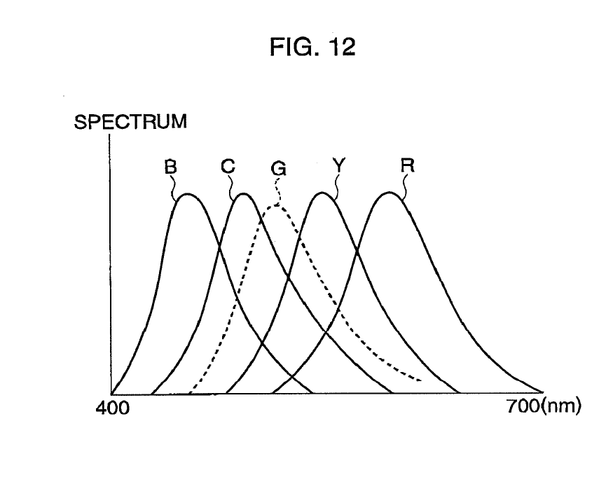

FIG. 10 is a block diagram of a digital camera according to the second embodiment. FIG. 11 illustrates a color filter array. FIG. 12 illustrates spectrum transmittance characteristics of the color filter array.

The digital camera 10′ is equipped with a CCD 14′ with an on-chip color filter array 13′ composed of four color elements. As shown in FIG. 11, the color filter array 13′ is a mosaic filter array of R, Y, C, and B color elements, and spectrums of color elements are distributed at approximately equal intervals (see FIG. 12). The color element “C” has a spectral distribution in which a peak occurs approximately at the midpoint between a peak of the color element “G” and a peak of the color element “B”. On the other hand, the color element “Y” has a spectral distribution in which a peak occurs approximately at the midpoint between a peak, of the color element “R” and a peak of the color element “G”.

Furthermore, the digital camera 10′ is equipped with a color-transform processor 20′, and a color interpolation processor 22′. In the color-transform processor 20′, missing color signals are temporarily interpolated by the proximity interpolation process, and a color matrix computation is carried out for generating color-transform signals, similarly to the first embodiment. At this time, color-transform signals corresponding to color elements Y and C are obtained as a color-transform signals corresponding to a color “G”.

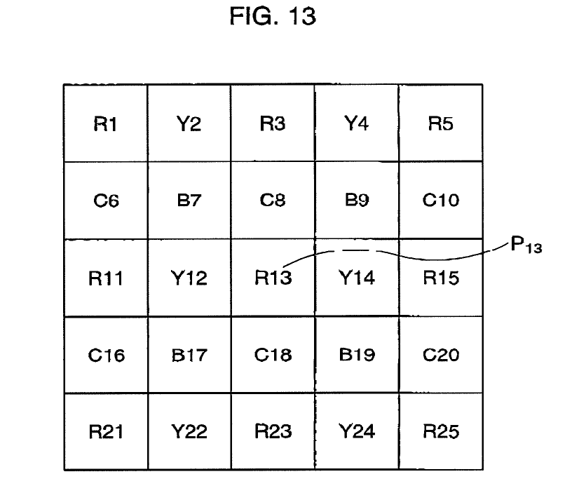

FIG. 13 illustrates color signals read from the CCD 14′ in accordance with 5×5 pixel array. For example, in the case of the pixel P₁₃, a color-transform signal Rc13 is calculated using the following formula.

$$Rc 13 = ( \begin{matrix}1.09 & 0.23 & - 0.36 & 0.04\end{matrix} ) ( \begin{matrix}R 13 \\ {Y}^{′} 13 \\ {C}^{′} 13 \\ {B}^{′} 13\end{matrix} ) \\ ( \begin{matrix}{Y}^{′} 13 = ( Y 12 + Y 14 ) / 2 \\ {C}^{′} 13 = ( C 8 + C 18 ) / 2 \\ {B}^{′} 13 = ( B 7 + B 9 + B 17 + B 19 ) / 4\end{matrix} ) \qquad ( 11 )$$

Also, a color-transform signal Gc14 of the pixel P₁₄, a color-transform signal Gc18 of the pixel P₁₈, and a color-transform signal Bc19 of the pixel P₁₉ are calculated using the following formulae.

$$\begin{matrix}Gc 14 = ( \begin{matrix}- 0.61 & 1.17 & 0.78 & - 0.33\end{matrix} ) ( \begin{matrix}{R}^{′} 14 \\ Y 14 \\ {C}^{′} 14 \\ {B}^{′} 14\end{matrix} ) \\ ( \begin{matrix}{R}^{′} 14 = ( R 13 + R 15 ) / 2 \\ {C}^{′} 14 = ( C 8 + C 10 + C 18 + C 20 ) / 4 \\ {B}^{′} 14 = ( B 9 + B 19 ) / 2\end{matrix} ) & ( 12 ) \\ Gc 18 = ( \begin{matrix}- 0.61 & 1.17 & 0.78 & - 0.33\end{matrix} ) ( \begin{matrix}{R}^{′} 18 \\ {Y}^{′} 18 \\ C 18 \\ {B}^{′} 18\end{matrix} ) \\ ( \begin{matrix}{R}^{′} 18 = ( R 13 + R 23 ) / 2 \\ {Y}^{′} 18 = ( Y 12 + Y 14 + Y 22 + Y 24 ) / 4 \\ {B}^{′} 18 = ( B 17 + B 19 ) / 2\end{matrix} ) & ( 13 ) \\ Bc 19 = ( 0. \begin{matrix}11 & - 0.21 & 0.21 & 1.32\end{matrix} ) ( \begin{matrix}{R}^{′} 19 \\ {Y}^{′} 19 \\ {C}^{′} 19 \\ B 19\end{matrix} ) \\ ( \begin{matrix}{R}^{′} 19 = ( R 13 + R 15 + R 23 + R 25 ) / 4 \\ {Y}^{′} 19 = ( Y 14 + Y 24 ) / 2 \\ {C}^{′} 19 = ( C 18 + C 20 ) / 2\end{matrix} ) & ( 14 )\end{matrix}$$

In the color interpolation processor 22′, just as in the first embodiment, the correlation interpolation process is also carried out. Thus, color-transform signals corresponding to color elements R, G, and B are generated. Note that the color signals “Y” and “C” are regarded as a color signal “G” in the correlation interpolation process. The proximity interpolation process may be carried out as well.

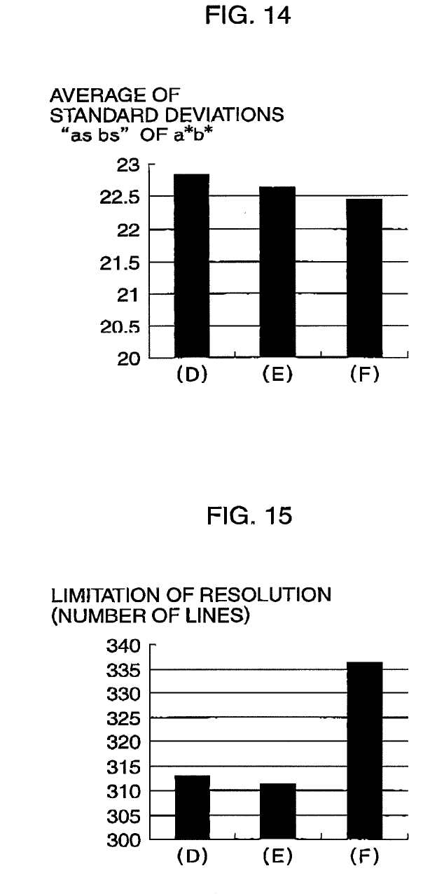

FIG. 14 shows a graph representing of the extent of false color occurrence when the subject is a, CZP chart. FIG. 15 shows a graph of resolution performance using a wedge chart.

As in the first embodiment, the average of standard deviations as and bs, and resolution limitation are derived in reference to three image-signal processes. In the process (D), the proximity interpolation process is initially carried out and then the color-transform process is carried out. The process (F) carries out the proximity interpolation process, color-transform process, and the correlation interpolation process, as explained above. The process (E) is almost the same as the process (F) except that the proximity interpolation process is carried out in the color interpolation processor 22′.

As can be seen from FIGS. 14 and 15, as for the processes (E) and (F), the averages are small and the number of line associated with the limitation of resolution is large, as compared to those of the prior process (D). Also, the process (F) can prevent the occurrence of false color and offers high resolution, compared to the process (R).

As for a color interpolation process, an interpolation process other than the proximity interpolation process (said linear interpolation process), and one other than the correlation interpolation process, may optionally be utilized. In this case, neighboring pixels or adjacent pixels may be used in the interpolation process for generating temporal color signals such that the occurrence of false color is prevented. On the other hand, surrounding pixels may be used with neighboring pixels such so as to obtain a high-resolution image.

As for the color space, one other than the sRGB color space, such as a YUV color space, La*b* color space, Lu*v* color space, X-Y-Z color system, etc., may be used. In addition, a complementary color filter array may be used rather than the R, G, and B color filter array.

The series of interpolation processes and the color-transform process may be carried out through software. Furthermore, the image-pixel signal process above may be performed in an imaging device other than the digital camera, such as a cellular phone, or an endoscope system, etc.

The present disclosure relates to subject matter contained in Japanese Patent Application No. 2008-141456 (filed on May 29, 2008), which is expressly incorporated herein by reference, in its entirety.

1. An imaging device comprising:
an image sensor with a mosaic color filter array comprising three or four color elements, the color elements arrayed such that each color element is opposite a pixel in said image sensor;
a color-transform processor that carries out a color-transform process on a color signal in each pixel to generate a single color-transform signal in each pixel; and
a color interpolation processor that interpolates at least one missing color-transform signal in each pixel using color-transform signals from surrounding pixels, said color-transform processor interpolating at least one missing color signal in each pixel using color signals generated over adjacent pixels, said color-transform processor multiplying the originally generated color signal and the interpolated color signal by color-transform coefficients to generate the single color-transform signal.

2. The imaging device of claim 1, wherein said color-transform processor interpolates color signals by carrying out an interpolation process based on color signals of neighboring pixels.

3. The imaging device of claim 2, wherein said color interpolation processor calculates an average of color signals from neighboring pixels.

4. The imaging device of claim 1, wherein said color interpolation processor carries out an interpolation process based on color-transform signals of a correlation pixel having a relatively strong correlation to a target pixel.

5. The imaging device of claim 4, wherein said color interpolation processor calculates color difference signals of the correlation pixel from color-transform signals of neighboring pixels and pixels adjacent to the neighboring pixels, and interpolates missing color-transform signal from the color difference signals and a color-transform signal of the target pixel.

6. The imaging device of claim 1, wherein said color interpolation processor calculates an average of color-transform signals from neighboring pixels.

7. The imaging device of claim 1, said color filer array comprises R, G, and B color elements.

8. The imaging device of claim 1, wherein said color filter array comprises R and B color elements and two color elements Y and C corresponding to a G color element.

9. The imaging device of claim 1, wherein said color-transform processor generates one of three color signals in each pixel.

10. An apparatus for interpolating color signals, comprising:
a color-transform processor that carries out a color-transform process on a color signal in each pixel to generate a single color-transform signal in each pixel of an image sensor, said image sensor having a mosaic color filter array comprising three or four color elements, the color elements arrayed such that each color element is opposite a pixel in said image sensor; and
a color interpolation processor that interpolates at least one missing color-transform signal in each pixel using color-transform signals from surrounding pixels, said color-transform processor interpolating at least one missing color signal in each pixel using color signals generated over adjacent pixels, said color-transform processor multiplying the originally generated color signal and the interpolated color signal by color-transform coefficients to generate the single color-transform signal.

11. A method for interpolating color signals, comprising:
carrying out a color-transform process on a color signal in each pixel to generate a single color-transform signal in each pixel of an image sensor, said image sensor having a mosaic color filter array comprising three or four color elements, the color elements arrayed such that each color element is opposite a pixel in said image sensor; and
interpolating at least one missing color-transform signal in each pixel using color-transform signals from surrounding pixels, said color-transform process interpolating at least one missing color signal in each pixel using color signals generated over adjacent pixels, said interpolating comprising multiplying the originally generated color signal and the interpolated color signal by color-transform coefficients to generate the single color-transform signal.
